(19) United States
(12) Patent Application Publication
(10) Pub. No.: US 2008/0241006 A1
(43) Pub. Date: Oct. 2, 2008

(54) EXHAUST GAS PURIFICATION APPARATUS

(75) Inventors: Minoru SATO, Tokyo (JP); Masato Kurahashi, Tokyo (JP); Sho Shiraga, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/020,065

(22) Filed: Jan. 25, 2008

(30) Foreign Application Priority Data
Mar. 28, 2007 (JP) 2007-085299

(51) Int. Cl. B01D 53/94

(52) U.S. Cl. 422/177

(57) ABSTRACT

An exhaust gas purification apparatus can efficiently purify an exhaust gas even when HC contained in the exhaust gas is excessive with a ratio of HC and NOx being substantially different from 1. The apparatus has an oxidation catalyst unit (8), a plasma processing unit (4) and a NOx purification catalyst unit (5) arranged on an exhaust gas flow passage, through which the exhaust gas discharged from an engine (1) flows, in this order form an upstream side to a downstream side. The oxidation catalyst unit (8) is provided with a main flow passage (31) through which the exhaust gas flows while being in contact with an oxidation catalyst, and a bypass flow passage (9) through which the exhaust gas flows without contacting the oxidation catalyst.

### BACKGROUND OF THE INVENTION

1. Field of the Invention

The present invention relates to an exhaust gas purification apparatus that serves to purify harmful components in an exhaust gas discharged from an engine.

2. Description of the Related Art

An exhaust gas discharged from an automotive engine contains nitrogen oxides (NOx), carbon monoxide (CO), and hydrocarbon (HC) as harmful components.

As a known apparatus for purifying such harmful gases, there has been put into practical use a three-way catalyst in the stoichiometric combustion in which residual oxygen (O₂) in the exhaust gas is in an extremely small amount. The harmful gas components are converted or changed to clean gases such as H₂O, CO₂ and N₂ by passing the exhaust gas from the engine through the three-way catalyst.

In contrast to this, exhaust gases of lean-burn engines and diesel engines contain a lot of oxygen, and it is difficult to purify NOx in the exhaust gases by means of a three-way catalyst.

Under such a circumstance, an exhaust gas purification apparatus is desired which can reduce the harmful components that are discharged from gasoline lean-burn engines or diesel engines and are difficult to be purified by the use of a three-way catalyst, and there has been proposed an exhaust gas treatment apparatus for motor vehicles which has a plasma processing unit incorporated in an exhaust pipe of an engine with a NOx purification catalyst unit connected to a downstream side of the plasma processing unit (see, for example, a first patent document: Japanese patent application laid-open No. H6-335,621).

This plasma processing unit is constructed such that there are provided discharge electrodes between which an exhaust gas passes. By processing the exhaust gas by means of a discharge plasma, oxygen molecules and water molecules in the exhaust gas are first dissociated as follows.

O₂2O*

H₂O→H*+OH*

The O* and OH* thus generated react with hydrocarbon (HC) and nitrogen monoxide (NO) in the form of harmful gases to finally generate formaldehyde, acetaldehyde, nitrogen dioxide (NO₂), carbon dioxide (CO₂), and water (H₂O).

HC+O*(or OH*)→aldehyde, CO₂, H₂O

NO+O*→NO₂

The aldehyde generated by the discharge chemical reactions is a reducing gas, and NO₂ is an oxidizing gas. The reducing gas and the oxidizing gas, when passed through the NOx purification catalyst unit in the following stage, react with each other on catalyst surfaces of the NOx purification catalyst unit to generate nitrogen (N₂), carbon dioxide (CO₂) and water (H₂O), whereby the exhaust gas is thus purified.

aldehyde+NO₂→N₂, CO₂, H₂O

In this manner, by subjecting the exhaust gas containing oxygen therein to the discharge plasma processing, the harmful components in the exhaust gas are activated to the reducing gas and the oxidizing gas with high reactivity, which are then caused to pass through the NOx purification catalyst unit, thereby purifying the exhaust gas.

In addition, there is also another example of making use of plasma for activation of an exhaust gas (see, for example, a second patent document: Japanese patent application laid-open No. 2006-29132).

In this example, NO₂, ozone (O₃) and the like with high oxidizing power are produced by discharging so as to regenerate a PM filter unit for capturing or collecting particulate matter (PM) in the exhaust gas.

A gas containing NO₂, O₃ and the like is supplied, as a regeneration gas, to the PM filter unit. The oxidizing gas containing NO₂, O₃ and the like serves to oxidize the particulates of soot captured or collected by the PM filter unit to convert them into CO₂, thereby regenerating the filter unit.

In the second patent document, a single PM filter is not able to perform collection and regeneration at the same time, so a plurality of PM filters, which constitute the PM filter unit, are provided so as to be used in an alternate manner. The PM filter unit is constructed such that when the PM filters are regenerated, the PM filters are separated or disconnected from an exhaust passage whereby a part of the exhaust gas is supplied to the PM filters through a plasma discharge reactor.

However, when a gasoline engine is operated under a lean burn condition, HC will be excessively contained in the exhaust gas with respect to NOx therein. As a result, in an exhaust gas treatment apparatus including the NOx purification catalyst unit and the plasma processing unit as stated above, the majority of radicals such as O*, OH*, etc., produced by electric discharge plasma react with HC, so radicals able to react with NOx becomes short or insufficient, and NO in the NOx can not be activated to NO₂.

When the exhaust gas includes such exhaust gas components, NO₂ in the form of a highly reactive oxidizing gas becomes short or insufficient, and the efficiency of electric discharge plasma processing is reduced, thereby making it necessary to input excessively large discharge energy.

Thus, there might be a situation in which the ratio of HC and NOx in the exhaust gas would become greatly different from 1 depending on the mode of operation of the engine, and in such a case, there is a problem of requiring excessively large discharge energy.

As a method of reducing the excessive HC contained in the exhaust gas, it can be considered that an oxidation catalyst is provided at a location or stage preceding the discharge plasma.

In case of the provision of such an oxidation catalyst, however, the exhaust gas under the lean burn condition contains a lot of oxygen, and HC in the exhaust gas reacts with the oxygen under the action of the oxidation catalyst, so the exhaust gas with only NOx remaining therein is supplied to the plasma processing unit, where aldehyde in the form of a reducing gas is not generated at all in the plasma processing unit, thus posing a problem that the NOx is not able to be purified by the NOx purification catalyst unit in the following stage.

In the above-mentioned second patent document, a part of the exhaust gas is branched and supplied to the plasma discharge reactor, but the ratio of HC and NOx in the branched exhaust gas is the same and unchanged, so in this case, there is a similar problem as stated above with the plasma discharge reactor.

### SUMMARY OF THE INVENTION

Accordingly, the present invention is intended to obviate the problems as referred to above, and has for its object to provide an exhaust gas purification apparatus which is capable of purifying an exhaust gas in an efficient manner even when HC contained in the exhaust gas is excessive with a ratio of HC and NOx being substantially different from 1.

Bearing the above object in mind, according to one aspect of the present invention, there is provided an exhaust gas purification apparatus in which an oxidation catalyst unit, a plasma processing unit and a NOx purification catalyst unit are arranged on an exhaust gas flow passage through which an exhaust gas discharged from an engine flows, in this order from an upstream side to a downstream side, wherein the oxidation catalyst unit is provided with a main flow passage through which the exhaust gas flows while being in contact with an oxidation catalyst, and a bypass flow passage through which the exhaust gas flows without contacting the oxidation catalyst.

According to another aspect of the present invention, there is provided an exhaust gas purification apparatus in which an oxidation catalyst unit, a plasma processing unit and a NOx purification catalyst unit are arranged on an exhaust gas flow passage through which an exhaust gas discharged from an engine flows, in this order from an upstream side to a downstream side, wherein a hydrocarbon supply unit is provided for supplying hydrocarbon to the exhaust gas flow passage at a location between the oxidation catalyst unit and the plasma processing unit.

According to an exhaust gas purification apparatus of the present invention, it is possible to efficiently purify an exhaust gas even when HC contained in the exhaust gas is excessive with a ratio of HC and NOx being substantially different from 1.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a schematic diagram showing the basic configuration of an exhaust gas treatment apparatus according to a first embodiment of the present invention.

FIG. 2 is a partially broken perspective view of a plasma processing unit shown in FIG. 1.

FIG. 3A is a perspective view of an oxidation catalyst unit shown in FIG. 1.

FIGS. 3B and 3C are perspective views showing individual modifications of the oxidation catalyst unit, respectively.

FIG. 4 is a schematic diagram showing the basic configuration of an exhaust gas treatment apparatus according to a second embodiment of the present invention.

FIG. 5 is a perspective view showing a modification of a bypass fluid passage shown in FIG. 4.

FIG. 6 is a schematic view showing the basic configuration of an exhaust gas treatment apparatus according to a third embodiment of the present invention.

FIG. 7 is a schematic diagram showing the basic configuration of an exhaust gas treatment apparatus according to a fourth embodiment of the present invention.

FIG. 8 is a schematic diagram showing the basic configuration of an exhaust gas treatment apparatus according to a fifth embodiment of the present invention.

FIG. 9 is a view showing the measurement results of the amount of generation of formaldehyde by a comparison between propane and propylene.

### DESCRIPTION OF THE PREFERRED EMBODIMENTS

Hereinafter, preferred embodiments of the present invention will be described in detail while referring to the accompanying drawings.

### Embodiment 1

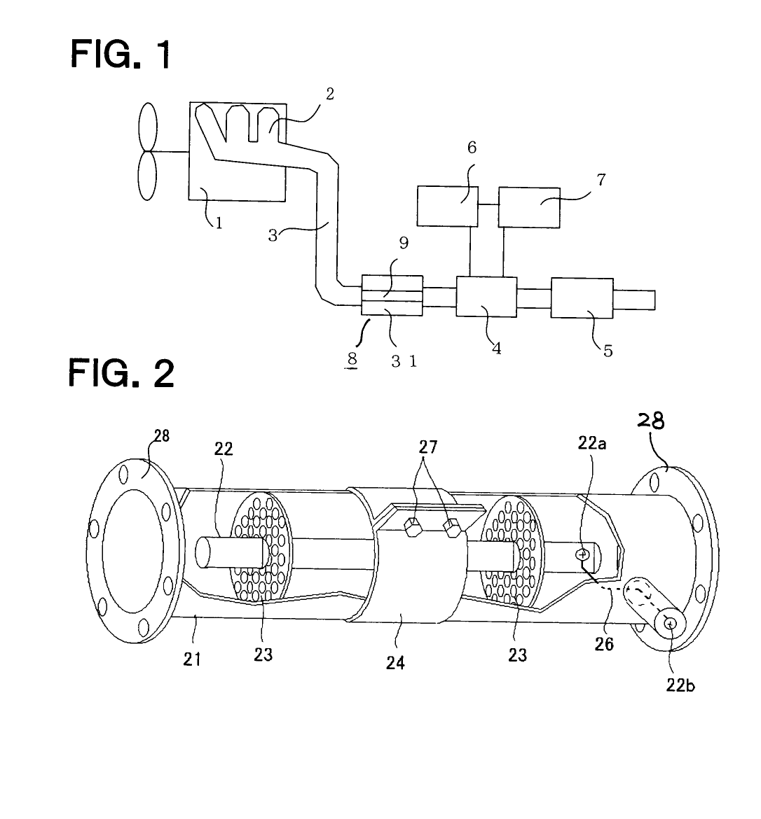

Referring to the drawings and first to FIG. 1, there is shown, in a schematic diagram, the basic configuration of an exhaust gas treatment apparatus according to a first embodiment of the present invention.

An engine 1 has several cylinders (not shown) provided therein, and an exhaust gas, which is generated by combustion of an air fuel mixture in the interior of each cylinder, is released to the outside through an exhaust manifold 2 and a single exhaust pipe 3.

In the exhaust gas treatment apparatus, an oxidation catalyst unit 8, a plasma processing unit 4, and a NOx purification catalyst unit 5 are arranged on the exhaust pipe 3, which forms an exhaust gas flow passage, in this order from an upstream side to a downstream side thereof.

The oxidation catalyst unit 8 is provided with a main flow passage 31 through which the exhaust gas flows while being in contact with an oxidation catalyst, and a bypass flow passage 9 which is formed in the center thereof and through which the exhaust gas flows without contacting the oxidation catalyst.

A plasma control unit 6 and a high voltage power supply 7 are electrically connected to the plasma processing unit 4. The plasma control unit 6 controls the amount of plasma generated by controlling the high voltage power supply 7, etc., based on monitored information on the generation condition of the plasma, information on the number of revolutions per minute of the engine 1, the temperature of the exhaust gas, etc., thereby to control the operation of the plasma processing unit 4.

FIG. 2 is a partially broken perspective view of the plasma processing unit 4. The plasma processing unit 4 is provided with an outer tube 21 through the interior of which the exhaust gas can be caused to flow from the left to the right in FIG. 2. The outer tube 21 is formed at its opposite ends with a pair of flanges 28, respectively, with which the oxidation catalyst unit 8 and the NOx purification catalyst unit 5 can be connected. The material of the outer tube 21 only need be an insulating material, but it is not limited to such one, and for example, ceramic such as aluminum oxide can be used.

A high voltage electrode 22 fixedly secured to the outer tube 21 by a mesh 23 is arranged in the interior of the outer tube 21 in alignment therewith. A high voltage electrode terminal 22a and a power supply terminal 22b are connected to the high voltage electrode 22 by means of a high voltage cable 26 for supplying a voltage. The power supply terminal 22b is electrically connected to the plasma control unit 6 through a cable (not shown). A ground electrode 24 is mounted on the outer tube 21 in surface contact therewith by tightening fastening screws 27. In addition, by tightening the fastening screws 27, a cable (not shown) for electrically connecting the ground electrode 24 to the plasma control unit 6 is attached to the ground electrode 24.

Here, note that the material of the mesh 23 only need be an insulator, and for example, ceramic such as aluminum oxide or the like can be used. Also, the materials of the high voltage electrode 22 and the ground electrode 24 only need be conductor, and for example, stainless steel can be used.

In the plasma processing unit 4 as constituted in this manner, a silent discharge is generated in a space between the high voltage electrode 22 and the outer tube 21 by impressing an alternating current high voltage or a pulsed high voltage between the high voltage electrode 22 and the ground electrode 24. The length in an exhaust gas flow direction of the space in which the silent discharge is generated is equal to the length in the exhaust gas flow direction of the ground electrode 24. In other words, the silent discharge occurs in the space enclosed by the ground electrode 24. The exhaust gas introduced into the plasma processing unit 4 passes first through the mesh 23 and then the interior of the silent discharge space. In the course of such passage, the exhaust gas performs chemical reactions by means of discharge plasma.

The oxidation catalyst unit 8 is mounted on an intermediate portion of the exhaust pipe 3 that forms the exhaust gas flow passage.

In the main flow passage 31 of the oxidation catalyst unit 8, an oxidation catalyst in the form of a noble metal type catalyst, especially platinum (Pt) or palladium (Pd), is carried by a honeycomb ceramic substrate of a beehive-like shape which has been conventionally used.

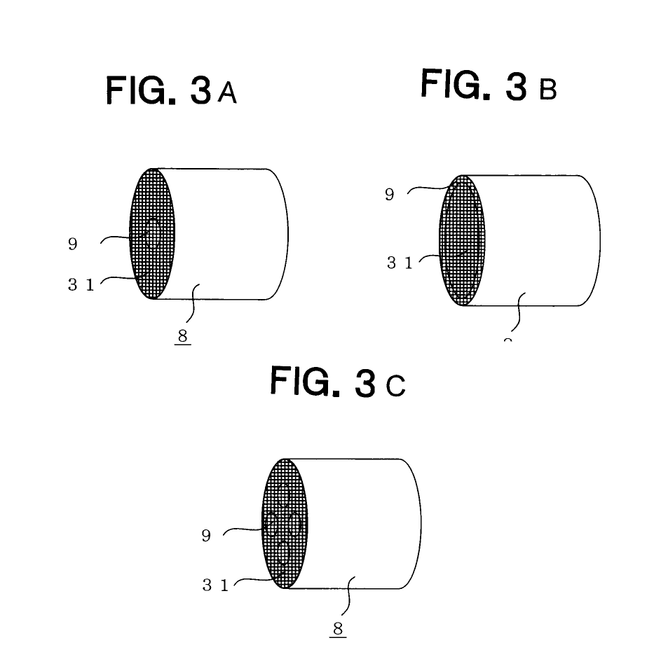

The bypass flow passage 9 is formed in the central portion of the oxidation catalyst unit 8 by which nothing is carried there, as shown in FIG. 3A.

Here, note that as shown in FIG. 3B, the bypass flow passage 9 may instead be formed in the outer peripheral portion of the oxidation catalyst unit 8 with no oxidation catalyst being carried in the outer peripheral portion of the oxidation catalyst unit 8. In this case, the main flow passage 31 in the oxidation catalyst unit 8, with which the exhaust gas is in contact, is arranged at a radially inner side of the bypass flow passage 9.

In addition, as shown in FIG. 3C, the bypass flow passage 9 may be formed in an arbitrary portion of the interior of the oxidation catalyst unit 8 with no oxidation catalyst being carried in the arbitrary portion of the oxidation catalyst unit 8. In this case, the main flow passage 31 of the oxidation catalyst unit 8 is a region excluding the bypass flow passage 9.

The oxidation catalyst unit 8 is constructed as follows. That is, when the catalyst is carried by the honeycomb-shaped ceramic substrate, the ceramic substrate is soaked in a catalytic solution with inlet and outlet openings in the portion of the ceramic substrate in which the catalyst is not carried are attached by masks for closing these openings, whereby the main flow passage 31, through which the exhaust gas flows while being in contact with the oxidation catalyst, is formed in the unmasked portion of the ceramic substrate, and the bypass flow passage 9 is formed in the masked portion of the ceramic substrate.

A mixture ratio adjusting unit is composed of the main flow passage 31 and the bypass flow passage 9. The mixture ratio adjusting unit is provided for adjusting mixture ratio of hydrocarbon and NOx in the exhaust gas supplied to the plasma processing unit 4 predetermined value.

In the NOx purification catalyst unit 5, too, similar to the above-mentioned oxidation catalyst, the catalyst is carried by a honeycomb ceramic substrate of a beehive-like shape, and there is used a silver catalyst, a zeolitic catalyst or the like that is carried by alumina in the ceramic substrate, which is assumed to be effective for purification reactions of aldehyde and NO₂.

In the exhaust gas purification apparatus of the above-mentioned construction, the exhaust gas collected by the exhaust manifold 2 is introduced into the oxidation catalyst unit 8 through the exhaust pipe 3. A portion of the exhaust gas thus introduced, which flows into the main flow passage 31, is in contact with the oxidation catalyst and is subjected to an oxidation treatment thereof. The oxidation treatment mentioned here is that HC and CO contained in the exhaust gas are changed or converted into CO₂ and H₂O. In addition, a part of NO in NOx is also changed or converted into NO₂.

The remaining portion of the exhaust gas introduced, which flows into the bypass flow passage 9, passes therethrough without any change. The individual portions of the exhaust gas, being thus divided to flow through the main flow passage 31 and the bypass flow passage 9, merge together and mix with each other, after which they are supplied to the plasma processing unit 4 and are subjected to a conversion treatment.

The conversion treatment mentioned here is to convert at least a part of HC contained in the exhaust gas mainly into aldehyde genera, as well as to convert NO in the exhaust gas into NO₂. Thereafter, the exhaust gas containing therein aldehyde and NO₂ obtained by the conversions reaches the NOx purification catalyst unit 5, where it is subjected to a purification treatment.

The purification treatment mentioned here is to convert the aldehyde and NO₂ contained in the exhaust gas into N₂, CO₂ and H₂O, as well as to convert remaining parts of HC and CO into CO₂ and H₂O.

However, in case where the exhaust gas purification apparatus according to this embodiment is applied to a gasoline lean-burn engine in which an exhaust gas contains O₂ of about several % to 10% in addition to HC, NOx and so on, the concentration of oxygen in the exhaust gas is high, so almost all the amount of components such as HC, CO and so on in the exhaust gas, which has passed through the main flow passage 31 in contact with the oxidation catalyst, are completely oxidized into CO₂ and H₂O by catalytic reaction with O₂.

Accordingly, the HC being in contact with the oxidation catalyst while passing through the main flow passage 31 reaches the outlet thereof at a zero concentration, and HC having passed through the bypass flow passage 9 reaches the outlet thereof at an unchanged concentration. In addition, in the oxidation catalyst, the concentration of NOx as a whole remains substantially constant or unchanged though a part of NO is converted into NO₂. NOx having passed the bypass flow passage 9 reaches the outlet without being converted at all.

The ratio of the one part of the exhaust gas flowing through the main flow passage 31 and the remaining exhaust gas flowing through the bypass flow passage 9 is decided by the ratio of inlet opening areas of the individual flow passages when the flow velocity distribution of the exhaust gas at the inlets of the oxidation catalyst unit 8 is uniform. The setting of such an inlet area ratio is decided by an actual ratio between the concentrations of HC and NOx contained in the exhaust gas and a target ratio between the concentrations of HC and NOx.

For example, in case where the C1 conversion concentration of HC in the exhaust gas is 3,000 ppmC, the concentration of NOx in the exhaust gas is 100 ppm, and the target ratio of HC/NOx is 1.0, the ratio of the area of the oxidation catalyst and the area of the bypass flow passage 9 should be set to 29:1.

When the area ratio of the main flow passage 31 and the bypass flow passage is set in this manner, the HC concentration at the outlet becomes 9,100 ppmC (═C1 conversion concentration), and the NOx concentration at the outlet becomes 100 ppm.

The target ratio of HC/NOx changes to a somewhat extent depending on the kind of aldehyde generated in the plasma processing unit 4. When formaldehyde HCHO is generated in the plasma processing unit 4, the following reaction occurs.

2HCHO+2NO₂→N₂+2CO₂+2H₂O

As a result, the ratio of formaldehyde and NOx, i.e., the ratio of HC/NOx, becomes 2/2=1.0. On the other hand, when acetaldehyde CH3CHO is generated in the plasma processing unit 4, the following reaction occurs.

4CH₃CHO+10NO₂→5N₂+8CO₂+8H₂O

As a result, the ratio of acetaldehyde and NOx, i.e., the ratio of HC/NOx, becomes 4×2/10=0.8.

Thus, the target HC/NOx ratio when setting the area of the bypass flow passage 9 is decided by an aldehyde generation property of the plasma processing unit 4.

When the one part of the exhaust gas having passed the main flow passage 31 and the remaining part thereof having passed the bypass flow passage 9 are mixed with each other and are supplied to the plasma processing unit 4, radicals such as O*, OH*, etc., generated by the plasma, act on HC and NOx in a substantially uniform manner, so they can be made use of effectively to produce aldehyde and NO₂ therefrom, respectively.

The aldehyde and NO₂ produced efficiently in the plasma processing unit 4 is then subjected to a purification treatment in the NOx purification catalyst unit 5.

As described above, according to the exhaust gas purification apparatus of the first embodiment, the concentrations of HC and NOx in the exhaust gas can be adjusted to a target ratio thereof by changing the area ratio of the main flow passage 31 and the bypass flow passage 9 at which the exhaust gas flows through these passages, respectively. As a result, the plasma processing unit 4 is able to convert HC into aldehyde and NO into NO₂ with a small amount of energy in an efficient manner.

In the NOx purification catalyst unit 5 following the plasma processing unit 4, the gas containing aldehyde of an optimal concentration for purification of NO₂ can be purified.

In addition, the oxidation catalyst unit 8 has the main flow passage 31 and the bypass flow passage 9 formed integral with each other, so no additional parts for the bypass flow passage 9 are required.

### Embodiment 2

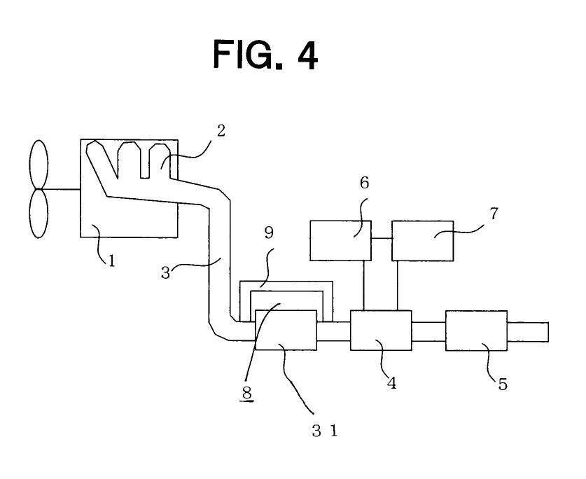

FIG. 4 is a schematic diagram that shows the basic configuration of an exhaust gas treatment apparatus according to a second embodiment of the present invention.

In this second embodiment of the present invention, an exhaust gas flow passage formed by an exhaust pipe 3 is provided with a main flow passage 31 having an oxidation catalyst carried therein, and a bypass flow passage 9 having no oxidation catalyst carried therein.

The other construction of this second embodiment is similar to that of the first embodiment.

In this second embodiment, piping forming the bypass flow passage 9 is composed of the same kind of metal pipe as the exhaust pipe 3.

The diameter of the bypass flow passage 9 is decided by the above-mentioned concentration ratio of HC and NOx contained in the exhaust gas and a target concentration ratio thereof.

Here, the main flow passage 31 in which the oxidation catalyst is carried is of a honeycomb structure, and the bypass flow passage 9 is of a pipe structure, so the diameter of the bypass fluid passage 9 is decided so as to provide the target ratio of HC/NOx in consideration of the numerical apertures of the main flow passage 31 and the bypass flow passage 9 in addition to the diameters thereof.

Specifically, in case of a ceramic honeycomb in which the main flow passage 31 has a cylindrical shape of a diameter of 100 mm, and a cell density of 400 cpsi (the number of cells per sq. in.), the numerical aperture of the main flow passage 31 is about 85%, and the effective area thereof through which the exhaust gas flows is about 6,700 mm2. Also, in case of the target ratio of HC/NOx being 1.0, the ratio of the effective area of the main flow passage 31 in which the oxidation catalyst is carried and the area of the bypass flow passage 9 need be set to 29:1, and the inner diameter of the bypass flow passage 9 in this case becomes about 17 mm. In actuality, fine adjustment is needed in consideration of the air-flow resistance due to the length of the main flow passage 31, the length of the bypass flow passage 9, the bendings of the main and bypass flow passages 31, 9, etc.

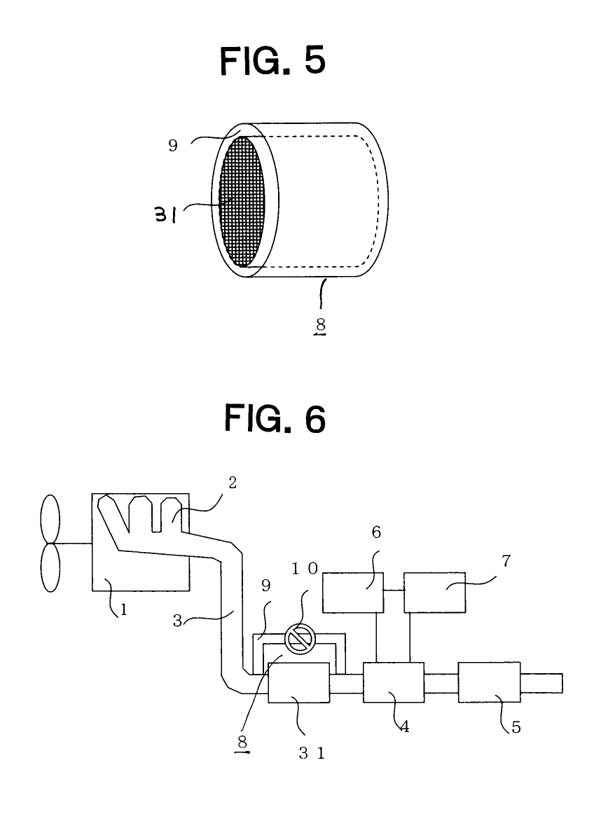

Here, note that the bypass flow passage 9 may be formed by a gap defined in an outer peripheral portion of the main flow passage 31 of a beehive-like shape, as shown in FIG. 5.

Thus, by forming the gap along a circumferential direction of an inner peripheral wall surface of the exhaust pipe 3, it is possible to integrate the main flow passage 31 and the bypass flow passage 9 with each other.

According to the exhaust gas purification apparatus of this second embodiment, by arranging the main flow passage 31 carrying the oxidation catalyst therein and the bypass flow passage 9 separately from each other, the concentration of HC and the concentration of NOx in the exhaust gas can be adjusted so as to provide a target ratio thereof, as in the first embodiment.

In addition, although the number of parts required increases as compared with that of the first embodiment, the bypass passage 9 may be formed by using a metal pipe as it is, and it becomes unnecessary to use a process of forming a bypass passage by soaking a honeycomb ceramic substrate in a catalytic solution with inlet and outlet openings therein being attached by masks for closing these openings.

### Embodiment 3

FIG. 6 is a schematic diagram that shows the basic configuration of an exhaust gas treatment apparatus according to a third embodiment of the present invention.

In this third embodiment of the present invention, a flow control unit 10 is provided on the bypass flow passage 9 of the above-mentioned second embodiment.

The construction of this third embodiment other than this is similar to that of the second embodiment. In the first and second embodiments, the sizes or dimensions of the main flow passage 31 carrying the oxidation catalyst therein and the bypass flow passage 9 are decided based on the concentrations of HC and NOx examined beforehand under the operating condition of the engine 1, whereby the distribution of the exhaust gas between the main flow passage 31 and the bypass flow passage 9 are set in an appropriate manner.

In contrast to this, in this third embodiment, by controlling the flow control unit 10, the bypass flow rate of the exhaust gas flowing through the bypass flow passage 9 can be made variable in accordance with the operating condition of the engine 1, and the range of the operating condition of the engine 1 can be made wider.

For example, in case where the air fuel ratio of a mixture in the engine 1 is 20, the methane conversion concentration (C1 conversion concentration) of HC in the exhaust gas is 3,000 ppm, and the concentration of NOx in the exhaust gas is 100 ppm, but when the air fuel ratio is set to 18, the HC concentration becomes 500 ppm and the NOx concentration becomes 2,500 ppm. As a result, it is possible to adjust the ratio of HC/NOx to a target ratio of 1.0 by increasing the flow rate of the exhaust gas flowing through the bypass flow passage 9 to change the ratio of the oxidation catalyst and the bypass flow passage 9 to 4:1.

For the concentrations of HC and NOx, there may be used those values which have been measured beforehand in accordance with the air fuel ratio of the mixture in the engine 1 and stored in the flow control unit 10, or the flow control unit 10 may be adjusted based on signals from sensors (not shown) that are installed on an intermediate portion of the exhaust pipe 3 for detecting HC, NOx and so on.

According to the exhaust gas purification apparatus of this third embodiment, the flow rate of the exhaust gas in the bypass flow passage 9 can be variably adjusted by means of the flow control unit 10. As a consequence, even when the concentrations of HC and NOx in the exhaust gas are changed, the HC/NOx ratio can be adjusted to the target value.

### Embodiment 4

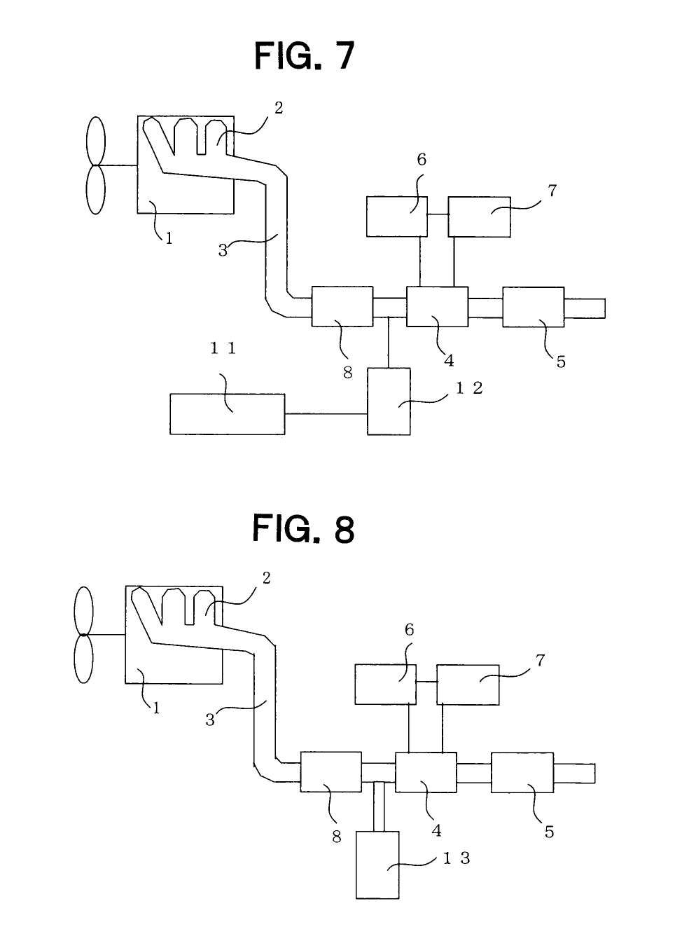

FIG. 7 is a schematic diagram that shows the basic configuration of an engine system equipped with an exhaust gas treatment apparatus according to a fourth embodiment of the present invention.

In a second embodiment of the present invention, in place of the bypass flow passage 9 in the above-mentioned first through third embodiments, a fuel supply unit 12 in the form of a hydrocarbon supply unit for supplying fuel such as gasoline from a fuel tank 11 is connected to an exhaust gas flow passage at a location between an oxidation catalyst unit 8 and a plasma processing unit 4.

The construction of this fourth embodiment other than the above is similar to that of the first embodiment.

In this fourth embodiment of the present invention, all the amount of the exhaust gas from an engine 1 passes through the oxidation catalyst unit 8 in which HC contained in the exhaust gas is oxidized to generate CO₂ and H₂O, and a part of NO in NOx is also oxidized into NO₂. At a location downstream of the oxidation catalyst unit 8, fuel containing an appropriate amount of HC corresponding to the concentration of NOx is supplied from the fuel tank 11 to the exhaust gas flow passage through the fuel supply unit 12. The fuel thus supplied is gasoline in case of a gasoline engine, and is a hydrocarbon having a carbon number of about 8. If the operating condition of the engine 1 is decided as in the first and second embodiments, an amount of fuel to be supplied, i.e., an amount of HC, may be a fixed amount. In addition, when the operating condition of the engine 1 is changed as in the third embodiment, an amount of HC corresponding to the engine operating condition thus changed need be supplied.

In case of supplying a liquid fuel such as gasoline, use of an atomizer such as an injector or the like for the fuel supply unit 12 can facilitate the mixing of the liquid fuel into the exhaust gas.

According to the exhaust gas purification apparatus of this fourth embodiment, the HC in the exhaust gas is removed by the oxidation catalyst and an amount of HC corresponding to the concentration of NOx in the exhaust gas is supplied from the outside. Thus, by supplying the amount of HC corresponding to the concentration of NOx in the exhaust gas, the HC/NOx ratio can be adjusted to an appropriate value.

In addition, fuel for engine use is supplied to the exhaust gas as HC, so a new or additional HC tank and the like are unnecessary.

### Embodiment 5

FIG. 8 is a schematic diagram that shows the basic configuration of an engine system equipped with an exhaust gas treatment apparatus according to a fifth embodiment of the present invention.

In this fifth embodiment, an unsaturated hydrocarbon supply unit 13 is connected to an exhaust gas flow passage at a location between an oxidation catalyst unit 8 and a plasma processing unit 4. The mixture ratio adjusting unit is the hydrocarbon supply unit 13.

The construction of this fifth embodiment other than the above is similar to that of the fourth embodiment.

This fifth embodiment of the present invention is similar to the above-mentioned fourth embodiment in that all the amount of an exhaust gas from an engine 1 passes through said the oxidation catalyst unit 8 in which HC contained in the exhaust gas is oxidized to generate CO₂ and H₂O, and a part of NO in NOx is also oxidized into NO₂.

At a downstream side of the oxidation catalyst unit 8, an appropriate amount of unsaturated hydrocarbon corresponding to the concentration of NOx in the exhaust gas is supplied from the unsaturated hydrocarbon supply unit 13 to the exhaust gas flow passage. If the operating condition of the engine 1 is decided as in the first and second embodiments, an amount of HC to be supplied may be a fixed amount, and when the operating condition of the engine 1 is changed as in the third embodiment, an amount of HC corresponding to the engine operating condition thus changed need be supplied.

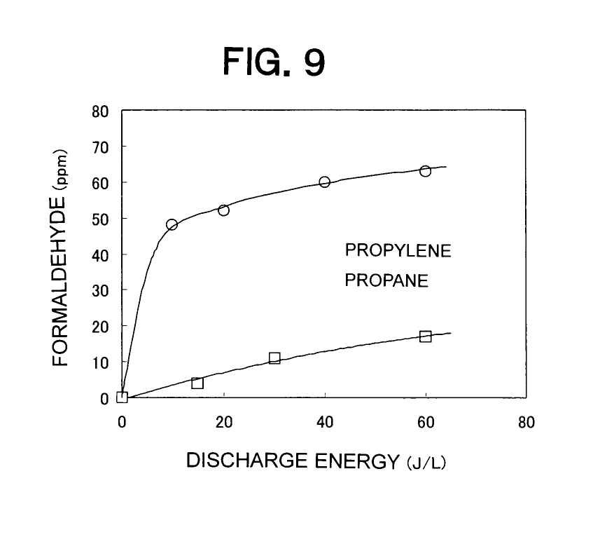

FIG. 9 shows experimental results that the inventor of the present inventor obtained by measuring formaldehyde generated in a plasma processing unit from a mixture of air and propylene, which is formed by mixing an unsaturated hydrocarbon in the form of propylene into the air, and from a mixture of air and propane, which is formed by mixing a saturated hydrocarbon in the form of propane into the air at the same concentration.

In this figure, the axis of abscissa represents input discharge energy per liter of gas.

From FIG. 9, it is found that the amount of aldehyde generated from propylene is greater as compared with that generated from propane in the same condition.

Accordingly, in the plasma processing unit 4, as for the kind of HC supplied to the exhaust gas, the HC can be converted into highly reactive aldehyde with a smaller amount of discharge energy in an efficient manner in case of using an unsaturated hydrocarbon in the form of propylene than in case of using a saturated hydrocarbon in the form of propane.

According to the exhaust gas purification apparatus of this fifth embodiment, the HC in the exhaust gas is removed by the oxidation catalyst unit 8, and the unsaturated hydrocarbon corresponding to the NOx concentration is supplied from the outside, so the HC/NOx ratio in the exhaust gas supplied to the plasma processing unit 4 can be adjusted to an appropriate value, and in the plasma processing unit 4, the NOx in the exhaust gas can be converted into highly reactive and reducing gases and highly oxidizing gases in an efficient manner.

Here, note that exhaust gas purification apparatuses according to the present invention are not limited to the ones that purify harmful components of an exhaust gas discharged from a gasoline lean-burn engine, but can be applied to diesel engines, too.

In addition, the present invention can also be applied to exhaust gas purification apparatuses for engines other than automotive use that purify harmful components of an exhaust gas discharged from a marine engine for example.

While the invention has been described in terms of preferred embodiments, those skilled in the art will recognize that the invention can be practiced with modifications within the spirit and scope of the appended claims.

What is claimed is:

1. An exhaust gas purification apparatus in which an oxidation catalyst unit, a plasma processing unit and a NOx purification catalyst unit are arranged on an exhaust gas flow passage through which an exhaust gas discharged from an engine flows, in this order from an upstream side to a downstream side,
wherein a mixture ratio adjusting unit is provided for adjusting mixture ratio of hydrocarbon and NOx in said exhaust gas supplied to said plasma processing unit predetermined value.

2. The exhaust gas purification apparatus as set forth in claim 1, wherein said oxidation catalyst unit is provided with a main flow passage through which said exhaust gas flows while being in contact with an oxidation catalyst, and a bypass flow passage through which said exhaust gas flows without contacting said oxidation catalyst,
said mixture ratio adjusting unit is composed of said main flow passage and said bypass flow passage.

3. The exhaust gas purification apparatus as set forth in claim 2, wherein said exhaust gas flow passage on which said oxidation catalyst unit is arranged is formed of a pipe with its interior divided into a first portion in which said oxidation catalyst is carried and a second portion in which said oxidation catalyst is not carried, and said first portion in which said oxidation catalyst is carried constitutes said main flow passage, and said second portion in which said oxidation catalyst is not carried constitutes said bypass flow passage.

4. The exhaust gas purification apparatus as set forth in claim 2, wherein said exhaust gas flow passage on which said oxidation catalyst unit is arranged is formed of a first flow passage in which said oxidation catalyst is carried and a second flow passage in which said oxidation catalyst is not carried, and said first flow passage in which said oxidation catalyst is carried constitutes said main flow passage, and said second flow passage in which said oxidation catalyst is not carried constitutes said bypass flow passage.

5. The exhaust gas purification apparatus as set forth in claim 4, wherein a flow control unit for controlling the flow rate of said exhaust gas is arranged on said bypass flow passage.

6. The exhaust gas purification apparatus as set forth in claim 1, wherein said mixture ratio adjusting unit is a hydrocarbon supply unit provided for supplying hydrocarbon to said exhaust gas flow passage at a location between said oxidation catalyst unit and said plasma processing unit.

7. The exhaust gas purification apparatus as set forth in claim 6, wherein said hydrocarbon is fuel for engine use.

8. The exhaust gas purification apparatus as set forth in claim 6, wherein said hydrocarbon is an unsaturated hydrocarbon.
